(19) United States
(12) Patent Application Publication
(10) Pub. No.: US 2007/0087256 A1
(43) Pub. Date: Apr. 19, 2007

(54) Fuel cell

(76) Inventors: Takayuki Hirashige, Hitachi (JP); Kenji Yamaga, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/581,342

(22) Filed: Oct. 17, 2006

(30) Foreign Application Priority Data
Oct. 18, 2005 (JP) 2005-302429

(51) Int. Cl. H01M 8/02; H01M 4/94

(52) U.S. Cl. 429/38; 429/44

(57) ABSTRACT

A PEFC (polymer electrolyte fuel cell) has a cathode separator for a PEFC working at 100° C. or higher. The cathode separator has gas passages to fed oxidant gas. Each of the passages increases the sectional area thereof with going down stream along with gas flow. That is, the PEFC has the cathode separator whose passage is configured that the downstream side sectional area thereof is larger than the upstream side sectional area thereof. In addition, the area of contact between the rib surface of the anode separator and a diffusion layer of an anode is larger than the area of contact between the rib surface of the cathode separator and a diffusion layer of the cathode.

### CLAIM OF PRIORITY

The present application claims priority from Japanese application serial no. 2005-302429, filed on Oct. 18, 2006, the content of which is hereby incorporated by reference into this application.

### FIELD OF THE INVENTION

The present invention relates to a PEFC (polymer electrolyte fuel cell) being designed so as to work at high temperatures.

### BACKGROUND OF THE INVENTION

A fuel cell is a device to convert chemical energy directly into electric energy. It is so designed as to generate electricity by electrochemical reaction using fuel (such as hydrogen and methanol) and oxidant gas (such as air). Fuel cells can be grouped as a solid polymer type, a phosphoric acid type, a molten carbonate type, a solid oxide type under sorts of electrolytes and working temperatures. The most promising of these fuel cells is PEFC (Polymer Electrolyte Fuel Cell). It is under active investigation because of its potential use as a household power supply and a mobile power supply.

A PEFC generates electric power by oxidation of hydrogen gas at the anode and reduction of oxygen gas at the cathode with the help of an electrolyte membrane of perfluorocarbonsulfonic acid resin which is a solid polymer. The electrolyte membrane of solid polymer as a proton conductor has catalyst layers to be electrodes on its both sides.

Each catalyst layer has a matrix structure composed of catalyst-supporting carbon and solid polymer electrolyte, so that the electrode reaction takes place on the three-phase interface where the catalyst supported on carbon, the electrolyte, and reactant come into contact with one another. The carbon in the form of particles joining together acts as a passage of electrons and the electrolyte acts as a passage for protons. The integral structure comprised of the cathode catalyst layer, the anode catalyst layer, and electrolyte membrane is referred to a MEA (Membrane Electrode Assembly). Diffusion layers for reaction gas supply and current collection are placed on outside surfaces of the cathode catalyst layer and the anode catalyst layer.

A cathode separator and an anode separator are placed on outside surfaces of the cathode diffusion layer and the anode diffusion layer respectively. The separators are used for feeding reaction gases to respective electrodes, partitioning between reaction gas passages of adjoining single cells, and collecting current from each electrode. Each separator is provided with grooves for feeding the reaction gas introduced from outside to the electrode surface. Members of the fuel cell are fastened to each other integrally with screws. There by each projection (it's called as rib hereinafter) between adjoining grooves of the separator pressurizes the diffusion layer and the electrolyte.

The PEFC uses hydrogen as a fuel, and uses air or oxygen as oxidant gas. The fuel and the oxidant gas are fed to their respective catalyst layers. The fuel reacts at the anode catalyst layer and the oxidant gas reacts at the cathode catalyst layer according to the following formulas (1) and (2), respectively. Thus, these reactions generate electric power.
H₂→2H⁺+2e⁻ (1)
O₂+4H⁺+4e⁻→2H₂O (2)

The PEFC usually works at 70-80° C. and the reaction according to the formula (2) produces water as liquid. Thus, the following two phases exist on the cathode separator. One thereof is a gas phase of air or oxygen; and the other is a liquid phase of water resulting from the reaction. A fast gas flow in the separator is required for smooth feed of the reaction gas to the electrode layer and for rapid discharge of water produced at the cathode. This requirement can be met by employing a separator with grooves (for a passage) having a small sectional area or having a serpentine pattern. The rib between grooves has a width of about 1.0 mm, a pitch of about 2.0 to 3.0 mm, and a height of about 0.7 to 1.0 mm. The Pitch is a center-to-center distance between adjacent ribs. The sectional area of each groove should be smaller than specified above to ensure a high flow rate; otherwise, the groove is clogged with water drops produced by the cathode catalyst layer.

However, this problem is not solved by merely reducing the sectional area of the groove because more water occurs as available electric current increases. A solution to this problem is disclosed in Japanese Patent Laid-open No. Hei 11-16590. According to this disclosure, the passage of the separator has ribs whose pitch or height gradually decreases in the direction of gas flow, so that it permits the reaction gas to flow at a constant rate. Moreover, Japanese Patent Laid-open No. 2004-247154 discloses a separator with gas passages whose each sectional area decrease with going downstream.

In recent year, there is a strong demand for a PEFC which works at high temperatures above 100° C. in place of existing ones which work at 70-80° C. This is because working at high temperatures provides the advantages of: improving the system's overall efficiency through effective use of waste heat; increasing the output density through decreased activation overvoltage; preventing flooding phenomenon; decreasing catalyst poisoning with carbon monoxide, and facilitating water control.

The working (operative) temperature raised from 70° C. to 100° C. or higher materially affects the cell structure. Because the water produced according to the formula (2) above remains as liquid at 70° C. but is vaporized at 100° C. and thereby deteriorate functions of the separator. In other words, the conventional separator designed for comparatively low working temperatures will pose serious problems if used for a PEFC working at high temperatures.

The following problem occurs when the conventional separator for a PEFC working at 70° C. is used for a PEFC working at 100° C. or higher. The conventional PEFC working at 70° C. is required that the separator has passages (grooves) with comparatively small sectional areas. Because, since two phases of air as oxidant gas and the produced water (liquid) exist in the vicinity of an outlet of each passage of the separator, the need for the small sectional area-passages arises from discharging the water smoothly from the separator in order to prevent the water from building up therein. On the other hand, in the case of the PEFC working at 100° C. or higher, since the produced water is vaporized, a mixture of air and the vaporized water exists in the vicinity of the outlet of each passage of the separator. In this situation, if the conventional passage structure provided for 70° C. is adopted in the separator of the PEFC, the pressure of the mixture in each passage of the separator increases as the mixture goes to the exist of the passage, the resulting pressure loss in the passage increases, and then a blower loss and a energy loss of the fuel cell are decrease. In addition, the built-up or backflow of the mixture may occur in the worst case.

Furthermore, the following another problem, which is a pressure difference between the anode and the cathode, also may occur when the conventional separator for a PEFC working at 70° C. is used for a PEFC working at 100° C. or higher. That is, since a PEFC working at 100° Corhigher produces the vaporized water to be in the form of gas, a mixture (gases) of air and the vaporized water exists in the cathode separator, with the result that the pressure in the cathode separator is higher than that in the anode separator. This implies that the MEA receives a higher pressure on its cathode side than on its anode side and hence the deterioration with time is promoted under stress from the cathode separator side.

As mentioned above, such problems with a pressure loss in the cathode separator and a pressure difference between the anode and the cathode will arise when the conventional separator for a PEFC working at 70° C. is used for a PEFC working at 100° C. or higher.

### SUMMARY OF THE INVENTION

In the case of using a PEFC working at high temperatures, a new type separator is required having a structure different from the conventional type separator for a PEFC working at low temperatures. The present invention is to provide a new type separator capable of decreasing the pressure loss in the vicinity of its outlet and thereby of decreasing the blower loss the fuel cell. The present invention also is to provide an anode/cathode separator structure capable of decreasing the mechanical stress to the MEA, thereby of extending its life.

The present invention provides a fuel cell with a cathode separator for a PEFC working at 100° C. or higher, by increasing the sectional area of each passage with going downstream in the cathode separator. That is, the PEFC has the cathode separator whose passage is configured that the downstream side sectional area thereof is larger than the upstream side sectional area thereof.

According to the present invention, it is capable of decreasing a pressure loss of each passage of the cathode separator, and then decreasing a blower loss and increasing energy efficiency of the fuel cell. It is also characterized by that the area of contact between the rib surface of the anode separator and the diffusion layer of the anode is larger than the area of contact between the rib surface of the cathode separator and the diffusion layer of the cathode. Thereby, a surface area supporting the MEA on the anode separator is larger than that on the cathode separator. Thus the MEA experiences a less amount of shear stress applied from the cathode to the anode.

### BRIEF DESCRIPTION OF THE DRAWINGS

FIG. 1 is a sectional view of parts separated in a fuel cell of one example where the present invention is applied.

FIG. 2 is a plane view of a cathode separator and an A-B line sectional view of the cathode separator in a conventional fuel cell.

FIG. 3 is a sectional view of a cathode separator corresponding A-B line of FIG. 2 in the fuel cell according to a first embodiment of the present invention.

FIG. 4 is a sectional view of a cathode separator corresponding A-B line of FIG. 2 in a fuel cell according to a second embodiment of the present invention.

FIG. 5 is a sectional view of parts separated in a fuel cell according to a third embodiment of the present invention.

FIG. 6 is a sectional view of parts separated in a fuel cell according to a fourth embodiment of the present invention.

FIG. 7 is a diagram illustrating I-V characteristics of the first and second embodiments of the present invention and the conventional example.

FIG. 8 is a diagram illustrating changes with time of the output voltages, with the current density kept at 200 mA/cm², in the third and fourth embodiments of the present invention and the conventional example.

### DETAILED DESCRIPTION OF THE PREFERRED EMBODIMENTS

The preferred embodiments of the present invention will be described in more detail with reference to the accompanying drawings.

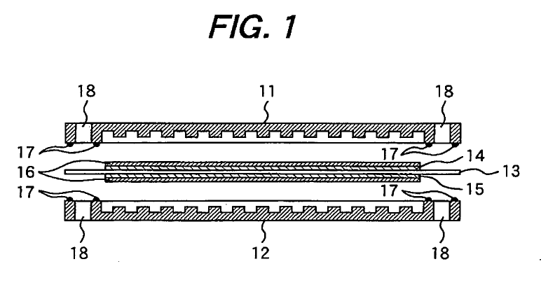

FIG. 1 shows the structure of a single cell of the fuel cell according to the present invention. The single cell is comprised of a cathode separator 11, an anode separator 12, an electrolyte 13, a cathode catalyst layer 14, an anode catalyst layer 15, gas diffusion layers 16, gaskets 17, and manifolds 18. An integral body comprised of the electrolyte 13, the cathode catalyst layer 14, and the anode catalyst layer 15 is referred to as MEA (Membrane Electrode Assembly). The cathode separator 11 has grooves formed on its one side surface to be in contact with the cathode catalyst layer 14. Likewise, the anode separator 12 has grooves formed on its one side surface to be in contact with the cathode catalyst layer 15. The former grooves supply oxygen or air to the cathode and the latter grooves supply fuel to the anode. The manifolds 18 feed gas to adjoining single cells. In the fuel cell that consumes hydrogen (as fuel) and air (as oxidant gas), the reactions represented by the equations (1) and (2) take place respectively in the anode catalyst layer 15 and the cathode catalyst layer 14.
H₂→2H⁺+2e⁻ (1)
O₂+4H⁺+4e⁻→2H₂O (2)
The reaction (1) in the anode catalyst layer 15 gives rise to protons, which move to the cathode catalyst layer 14 through the solid polymer electrolyte 13.

The gas diffusion layer 16 is made of carbon paper or carbon cloth with water repellent treatment. The gasket 17 is made of any material, such as butyl rubber, viton rubber, and EPDM rubber, which has insulating properties, low hydrogen permeability, and high airtightness. Fuel and oxygen (or air) are fed to the MEA by way of the anode separator 12 and the cathode separator 11, respectively. Any practical PEFC of stationary or mobile type comprises hundreds of single cells (shown in FIG. 1) being stacked on top of each other in layers.

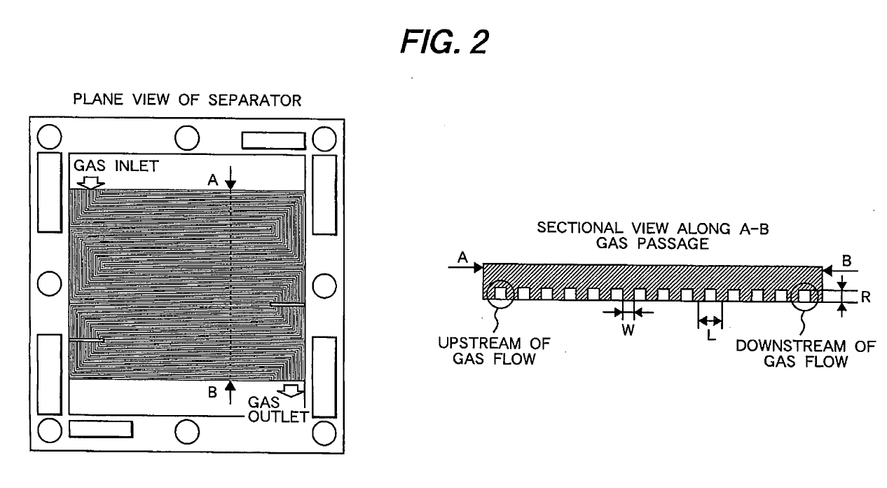

FIG. 2 shows a conventional separator designed for operation at 70-80° C. As shown in the plane view of the separator of FIG. 2, the separator (both of the cathode separator and the anode separator) has a plurality of grooves as gas passages that permit the reaction gas (introduced from the adjoining single cell through the manifold) to flow from the respective gas inlets to the respective gas outlets. The sectional view of FIG. 2 shows grooves to be passages of the separator in schematic form taken along the line A-B. The separator has a plurality of ribs at both sides of each groove for forming grooves. The ribs are defined by rib pitch (L), rib width (W), and rib height (R). The conventional separator has a rib pitch (L) of about 2.0 to 3.0 mm, a rib height (R) of about 0.7 to 1.0 mm, and a rib width (W) of about 1.0 mm. The passage has so a small sectional area as to prevent water produced by the cathode catalyst layer 14 from adhering in form of water drops in the grooves. That is, this passage structure ensures a high flow rate by narrowing the sectional area of each passage to discharge water smoothly.

The working temperature for the PEFC can be raised from 70-80° C. to 100° C. or higher by changing the electrolyte 13 from a single membrane of solid polymer (such as Nafion) to a composite membrane of solid polymer containing a moisture-retentive inorganic material dispersed therein. This change affects the structure of the fuel cell because the water produced by the reaction (2) becomes vapor at the raised working temperature. The water vapor at high temperatures greatly increases the pressure in the cathode separator 11. Although it is only 0.0386 MPa at 75° C. (equivalent to saturated vapor pressure), it increases to 0.101 MPa at 100° C., 0.232 MPa at 125° C., and 0.476 MPa at 150° C. Such pressure increase poses the following problems if the conventional separator (as shown in FIG. 2) for comparatively working low-temperature is used for the PEFC that works at high temperatures.
1. Fist problem: Increase in a pressure loss in the cathode separator.
2. Second problem: Increase in a pressure difference between the anode and the cathode.

First, the first problem and means for its solution is expressed hereinafter. The water produced by the reaction at the cathode remains in liquid state at the conventional working temperature (70° C.) but vaporizes in the PEFC working at high temperatures (100° C. or higher) . Thus a mixture gas composed of air and water vapor exists in the vicinity of the outlet of each passage of the separator so that the pressure in the passage increases. This pressure increase causes a pressure loss in the cathode separator and also a blower loss. In addition, the built-up or backflow of the mixture may occur in the worst case.

The cathode separators according to embodiments of the present invention differ from the conventional one in that the passage has a sectional area which increases with going downstream. This structure prevents the pressure increase in the vicinity of the outlet of the passage of the cathode separator, thereby decreasing the pressure loss. Consequently the structure is capable of decreasing a blower loss and improving energy efficiency.

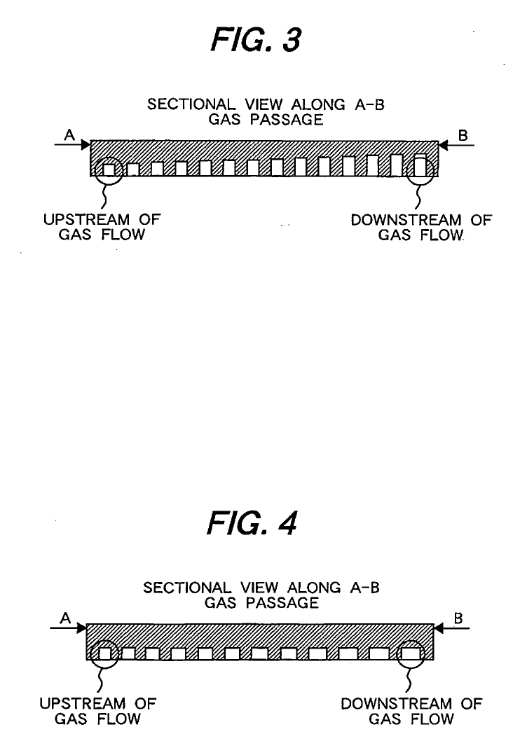

In the embodiments, in order to increase the sectional area of each passage with going downstream, the passage of the cathode separator has the rib height (in other words, the height of each groove) being varied so as to increase its height with going downstream as shown in FIG. 3, or the rib pitch (in other words, the width of each groove) being varied so as to increase its rib pitch with going downstream as shown in FIG. 4.

In the case of the embodiment (first embodiment) of FIG. 3, as shown in a sectional view of the passage of the cathode separator, the rib height should preferably increase from 0.2-0.7 mm at the inlet of the separator to 0.6-2.0 mm at the outlet thereof. In this embodiment, the separator should preferably be formed as thin as possible in consideration of the total thickness of the PEFC stack. The rib height can be increased only under the sacrifice of the separator thickness. Therefore an excessively high rib height results in an excessively thin separator thickness. The rib height should preferably be 1.5 mm or less for the separator to have enough strength. On the other hand, the rib height should preferably be 0.8 mm or more, more preferably 1 mm or more, for the pressure loss to be sufficiently decreased in the vicinity of the outlet of the passage of the cathode separator.

In the case of the embodiment (second embodiment) of FIG. 4, as shown in a sectional view of the passage of the cathode separator, the rib pitch should preferably increase from 1.0-3.0 mm at the inlet of the separator to 3.0 -9.0 mm at the outlet thereof. In this embodiment, a desirable rib pitch is 6.0 mm or less because an excessively large rib pitch reduces the contact area between the ribs and the diffusion layer, thereby increasing the contact resistance.

The second problem (increase in a pressure difference between the anode and the cathode) means for its solution is expressed hereinafter. This problem may occur when the conventional separator for a PEFC working at 70° C. is used for a PEFC working at 100° C. or higher. Because the water produced at the cathode separator in a PEFC exists in the form of water vapor and hence pressure in the cathode separator 11 exceeds pressure in the anode separator 12. This pressure difference results that a pressure on the cathode side is higher than a pressure on the anode side of the MEA. Consequently, the MEA receives a shearing force in the direction from the cathode side to the anode side. This shearing force deteriorates the MEA.

In the embodiments, in order to meet with the second problem, a contact area between the anode separator 12 and the gas diffusion layer 16 facing the anode is larger than a contact area between the cathode separator 11 and the gas diffusion layer 16 facing the cathode. This means that the MEA is supported on a larger area at the anode side than at the cathode side, and hence the MEA is less subject to shear force, the resulting achieves an extended life of the MEA.

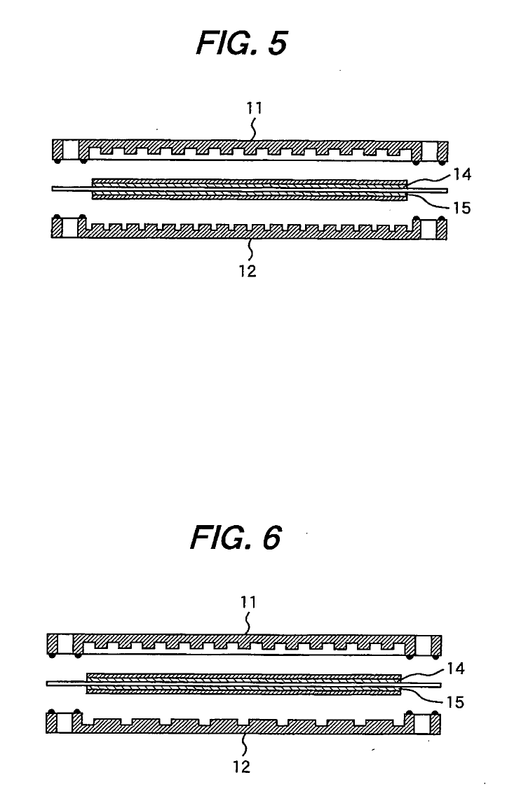

In order to making the contact area between the anode separator 12 and the anode side-gas diffusion layer 16 larger than that between the cathode separator 11 and the cathode side-gas diffusion layer 16, anyone of the following two means is adopted. That is, one is characterized by making the rib pitch of the anode separator 12 smaller than that of the cathode separator 11, as shown in FIG. 5. The other one is characterized by making the rib width of the anode separator 12 larger than that of the cathode separator 11, as shown in FIG. 6. In the case of the embodiment (third embodiment) of FIG. 5, as shown in a sectional view of separated parts of the single cell, the rib pitch for each passage of the cathode separator 11 should preferably be 1.5-9.0 mm, and the rib pitch for each passage of the anode separator 12 should preferably be 1.0 -2.0 mm.

In the case of the embodiment (third embodiment) of FIG. 6, as shown in a sectional view of separated parts of the single cell, the rib width for each passage of the anode separator should preferably be 1.0 -2.0 mm, and the rib width for each passage of the cathode separator should preferably be 0.5-1.0 mm. In the case of the latter, a further adequate rib width for low contact resistance is 0.8 mm.

The sectional shape of the passages of the respective separators may be square, triangular, or rectangular. The passages of the separators also have a pattern of parallel, serpentine, parallel-serpentine, or grid. The serpentine pattern is desirable for uniform gas distribution in the electrodes.

The separator may be formed from any material which possesses both high strength and good moldability or formability. Such material is exemplified by densification graphite plate, carbon plate which is formed by resin molded component containing carbonaceous material, such as graphite and carbon black), and corrosion-resistant metal, such as stainless steel and titanium alloy. It is desirable for the separator to undergo surface treatment, such as plating with noble metal and coating with an electrically conductive paint having good corrosion resistance and heat resistance.

The separator may be produced by any way suitable to forming the passage specified in the present invention. For example, when producing the separator from densification graphite as carbonaceous material, the producing method comprises the following steps: a first step of forming the passage on the densification graphite plate by cutting with a precision cutting machine; and a second step of making the separator impermeable to gas by vacuum-impregnation with a liquid resin so that the separator is cured. Another producing method for the separator using carbonaceous material is suggested by molding the separator from compound of carbonaceous material and resin powder with a compression molding machine. Further another method is suggested by molding the separator from pellet-like compound of thermoplastic resin, filler, and electrically conductive particulate carbon with an injection molding machine.

The separator of metallic material may be produced by pressing a thin sheet of stainless steel or titanium alloy, thereby forming the grooved passage.

The electrolyte suitable for working at 100° C. or higher may be formed from a composite material of a solid polymer and an inorganic material having moisture retention. The inorganic material with moisture retention includes zirconium oxide hydrate, tungsten oxide hydrate, tin oxide hydrate, niobium-doped tungsten oxide, silicon oxide hydrate, phosphorous oxide hydrate, zirconium-doped silicon oxide hydrate, tungstophosphoric acid, and molybdophosphoric acid. More than one species of metal oxide hydrate may used in combination with one another. The solid polymer includes the following materials: perfluorocarbonsulfonic acid; and materials made of polystyrene or engineering plastics (such as, polyetherketone, polyether ether ketone, polysulfone, and polyethersulfone) having a proton donor (such as sulfonic acid group, phosphonic acid group, and carboxyl group) doped there with or chemically linked or fixed thereto. The foregoing materials may be stabilized by crosslinking or partial fluorination.

The MEA suitable for working at 100° C. or higher may be produced in the following method. First, a cathode catalyst paste is prepared from a mixture of platinum-supporting carbon and solid polymer electrolyte dissolved in a solvent. An anode catalyst paste is also prepared from a mixture of platinum-ruthenium alloy-supporting carbon and solid polymer electrolyte dissolved in a solvent. Next, the pastes are sprayed (by spray-drying method) separately onto a peelable film of polytetrafluoroethylene (PTFE), followed by drying (for solvent removal) at 80° C. Thus there are obtained cathode and anode catalyst layers. Next, the composite electrolyte containing a moisture retention inorganic material is sandwiched by both catalyst layers, and they are joined to each other by hot pressing. Finally, the peeling films are removed.

The same object as above may be achieved by spraying the cathode and anode catalyst pastes (prepared as mentioned above) onto a composite electrolyte containing a moisture retention inorganic material. It is desirable to add the a moisture retention inorganic material to the solid polymer electrolyte in the catalyst layer.

The invention will be described in more detail with reference to the following Embodiments, which are not intended to restrict the scope thereof.

### EMBODIMENT 1

This embodiment demonstrates an MEA capable of working at 100° C. or higher. The MEA has a composite electrolyte composed of S-PES (sulfonated polyether sulfone) as an organic polymer and zirconium oxide hydrate ZrO₂·nH₂O (as a moisture retention inorganic material) dispersed therein. The S-PES has an ion exchange capacity of 1.3 meq/g on dry basis. The zirconium oxide hydrate ZrO₂·nH₂O was derived from zirconium oxychloride ZrOCl₂·8H₂O as a precursor. A first varnish of ZrOCl₂·8H₂O (30 wt % in concentration) dissolved in dimethylsulfoxide was prepared. A second varnish of S-PES (30 wt % in concentration) dissolved in dimethylsulfoxide was prepared. The two vanishes were mixed with stirring for 2 hours by using a stirrer. The resulting varnish mixture was applied onto a glass plate by using an applicator, followed by vacuum drying at 80° C. for 1 hour and at 120° C. for 3 hours for evaporation of dimethylsulfoxide. The resulting film was peeled off from the glass plate and then immersed in a 25 wt % aqueous solution of ammonia (NH3), so that the following reaction took place in the film.
ZrOCl₂·8H₂O+(n+1)H₂O→ZrO₂·nH₂O+2H⁺+2Cl⁻
Then, the film was immersed in a 0.5 M aqueous solution of KOH to remove Cl⁻ions and further washed in pure water. Finally, the film was immersed in a 1 M aqueous solution of H₂SO₄ for protonation. Thus there was obtained a white 50 μm thickness electrolyteof S-PES (with an ion exchange capacity of 1.3 mel/g) containing ZrO₂·nH₂O (50 wt %) dispersed therein.

The electrolyte was combined with cathode and anode catalyst layers to make the MEA in the following manner. The catalyst is platinum-supporting carbon: “TEC10V50E” (from Tanaka Kikinzoku) with a platinum content of 50 wt %. First, a catalyst slurry consisting of a catalyst, water, and 5 wt % Nafion solution (from Aldrich) in a ratio of 1:1:8.46 by weight was prepared by mixing and stirring. The thus obtained catalyst slurry was applied to a Teflon (trade mark) sheet by using an applicator to form a cathode catalyst layer and an anode catalyst layer, each containing 0.3 mg/cm² of platinum. Then the cathode and anode catalyst layers were attached to the electrolyte by hot-pressing to give the desired MEA whose catalyst layer has an area of 100 cm².

The resulting MEA (which is designed for high-temperature operation) was combined with the separators according to the present invention to make a single cell for testing. The separators were placed on both sides of the MEA, with PTFE-treated water-repellent carbon paper interposed between the MEA and the separator. All the components were fastened with bolts. The cathode separator according to the present invention has a rib height that increases with going downstream along the gas flow. For example, the rib height increases from 0.5 mm at the inlet to 2.0 mm at the outlet. The cathode separator also has a rib pitch of 2.0 mm and a rib width of 1.0 mm. The anode separator has a rib height of 1.0 mm, a rib width of 1.0 mm, and a rib pitch of 2.0 mm. Both the cathode and anode separators were made of carbon. The single cell for testing was placed in a thermostat and connected to the respective gas feed lines for anode and cathode, and the respective gas discharge lines for anode and cathode. The gas feed lines are respectively equipped with heaters to raise the gas temperatures. The discharged lines are respectively equipped with pressure regulators and heaters to keep the discharged gas at an adequate temperature. The anode gas is pure hydrogen and the cathode gas is air. The anode gas was humidified by using a bubbler at 90° C. The single cell was kept at 120° C. with a rubber heater. The single cell was connected to an electronic device to be road. In this state, the single cell was tested for output voltage at an output current of 200 mA/cm². During testing, the pressure at the inlet of the cathode separator was measured, with the outlet of the cathode separator kept open.

### EMBODIMENT 2

The same procedure as in Embodiment 1 was repeated to prepare the MEA suitable for working at 100° C. or higher.

The resulting MEA was combined with the separators according to the present invention to make a single cell for testing. The separators were placed on both sides of the MEA, with PTFE-treated water-repellent carbon paper interposed between the MEA and the separator. All the components were fastened with bolts. The cathode separator according to the present invention has a rib pitch that increases with going downstream along the gas flow. For example, the rib pitch increases from 2.0 mm at the inlet to 6.0 mm at the outlet. The cathode separator also has a rib height of 1.0 mm and a rib width of 1.0 mm. The anode separator has a rib height of 1.0 mm, a rib width of 1.0 mm, and a rib pitch of 2.0 mm.

Test for power generation was performed under the same conditions as in Embodiment 1. During testing, the pressure at the inlet of the cathode separator was measured, with the outlet of the cathode separator kept open, in the same way as in Embodiment 1.

### COMPARATIVE EXAMPLE 1

The same procedure as in Embodiment 1 was repeated to prepare the MEA suitable for working at 100° C. or higher.

The resulting MEA was combined with the conventional separators (suitable for working at 70° C.) to make a single cell for testing. The separators were placed on both sides of the MEA, with PTFE-treated water-repellent carbon paper interposed between the MEA and the separator. All the components were fastened with bolts. The cathode separator has a uniform rib height which is 1.0 mm at both the inlet and outlet. The cathode separator also has a rib width of 1.0 mm and a rib pitch of 2.0 mm. The anode separator has a rib height of 1.0 mm, a rib width of 1.0 mm, and a rib pitch of 2.0 mm. The single cell was tested under the same conditions as in Embodiment 1.

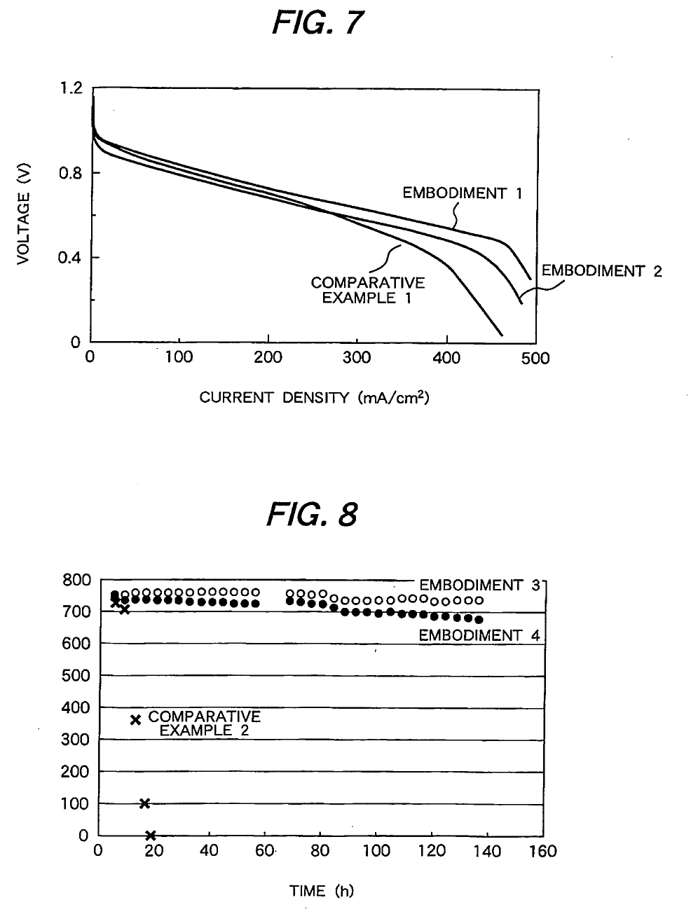

The I-V characteristic curves of the single cells in Embodiments 1, 2 and Comparative Example 1 are shown in FIG. 7. As shown in FIG. 7, the single cells in Embodiments 1 and 2 exhibit better output performance than that in Comparative Example 1. This performance is exhibited particularly in the high-current region in which more water is produced. The single cell in Embodiment 1 is superior in output performance to that in Embodiment 2. A probable reason for this is that the single cell in Embodiment 2 has the rib pitch which increases with going from the separator inlet to the separator outlet, resulting in a smaller contact area between the diffusion layer and all the ribs of the separator and hence a larger contact resistance than the single cell in Embodiment 1. Table 1 below shows the respective pressures at the inlets of the cathode separators in the single cells in Embodiments 1 and 2 and Comparative Example 1. Table 1 also shows, for comparison, the pressure measured when the single cell in Comparative Example 1 was run at 70° C. It is noted that the pressure at the inlet of the carbon separator in Comparative Example 1 increased from 4.8 kPa to 9.1 kPa when the working temperature rose from 70° C. to 120° C. This is because working at a high temperature causes a mixture gas of air and vaporized water existing in the separator (particularly in the vicinity of the outlet of the separator), with the pressure greatly increasing. Supplying air to the separator results in a large blower loss. By contrast, the pressure at the inlet of the separator was 5.0 kPa in Embodiment 1 and 5.2 kPa in Embodiment 2. This indicates that it is possible to keep the pressure low according to the present invention. The low pressure leads to a reduced blower loss and hence an improved energy efficiency for the fuel cell.

TABLE 1

| | At 120° C. | | | At 70° C. |
|---|---|---|---|---|
| | | | Comparative | Comparative |
| | Embodiment 1 | Embodiment 2 | Example 1 | Example 1 |
| Pressure at | 5.0 kPa | 5.2 kPa | 9.1 kPa | 4.9 kPa |
| inlet of | | | | |
| cathode | | | | |
| separator | | | | |

### EMBODIMENT 3

The same procedure as in Embodiment 1 was repeated to prepare the MEA suitable for working at 100° C. or higher.

The resulting MEA was combined with the separators according to the present invention to make a single cell for testing. The separators were placed on both sides of the MEA, with PTFE-treated water-repellent carbon paper interposed between the MEA and the separator. All the components were fastened with bolts. The cathode separator according to the Embodiment has a uniform rib pitch of 6.0 mm (at both the inlet and outlet). The cathode separator also has a rib height of 1.0 mm and a rib width of 1.0 mm. The anode separator has a uniform rib pitch of 2.0 mm at both the inlet and the outlet. It also has a rib height of 1.0 mm and a rib pitch of 1.0 mm.

The single cell was tested for life by measuring the variation in voltage with time, with the current density kept at 200 mA/cm².

### EMBODIMENT 4

The same procedure as in Embodiment 1 was repeated to prepare the MEA suitable for working at 100° C. or higher.

The resulting MEA was combined with the separators according to the present invention to make a single cell for testing. The separators were placed on both sides of the MEA, with PTFE-treated water-repellent carbon paper interposed between the MEA and the separator. All the components were fastened with bolts. The cathode separator according to the present invention has a uniform rib width of 1.0 mm (at both the inlet and outlet). The cathode separator also has a rib height of 1.0 mm and a rib pitch of 1.0 mm. The anode separator has a uniform rib width of 2.0 mm at both the inlet and the outlet. It also has a rib height of 1.0 mm and a rib pitch of 1.0 mm.

The single cell was tested for life by measuring the variation in voltage with time, with the current density kept at 200 mA/cm².

### COMPARATIVE EXAMPLE 2

The same procedure as in Embodiment 1 was repeated to prepare the MEA suitable for working at 100° C. or higher.

The resulting MEA was combined with the conventional separators (namely suitable for working at 70° C.) to make a single cell for testing. The separators were placed on both sides of the MEA, with PTFE-treated water-repellent carbon paper interposed between the MEA and the separator. All the components were fastened with bolts. The cathode separator has a rib width of 1.0 mm and a rib height of 1.0 mm (which are constant at both the inlet and outlet). It also has a rib pitch of 2.0 mm. The anode separator has a rib width of 1.0 mm and a rib height of 1.0 mm (which are constant at both the inlet and the outlet). It also has a rib pitch of 2.0 mm.

The single cell was tested for life by measuring the variation in voltage with time, with the current density kept at 200 mA/cm².

FIG. 8 shows the variation in voltage with time, with the current density kept at 200 mA/cm², which was measured in Embodiments 3 and 4 and Comparative Example 2. It is noted that the voltage dropped to zero at 18 hours after the start of power generation in Comparative Example 2. A probable reason for this is that high-temperature working at 120° C. causes the pressure to increase more in the cathode separator than in the anode separator and this pressure difference applies a shearing force (from the cathode to the anode) to the MEA, thereby cracking the MEA. This cracking was actually confirmed on inspection of the disassemble cell. By contrast, the single cells in Embodiments 3 and 4 showed no sign of voltage decrease even after working for 140 hours. This is because the MEA is supported more strongly by the anode separator than the cathode separator, which protects the MEA from cracking.

Incidentally, the above-mentioned embodiments may have a hydrogen storage-feed system. It is capable of implementing the hydrogen storage-feed by using a hydrogenation reaction of a hydrogen storage comprising aromatic compound and a dehydrogenation reaction of hydrogen supply comprising hydrogenation derivative of the aromatic compound.

What is claimed is:

1. A polymer electrolyte fuel cell for working at 100° C. or higher, comprising an anode catalyst layer to oxidize fuel, a cathode catalyst layer to reduce oxidant gas, an ionic conductor interposed between both catalyst layers, diffusion layers placed outside the anode and cathode catalyst layers, and an anode separator and a cathode separator placed outside the diffusion layers,
wherein the cathode separator has a gas passage whose sectional area increases with going downstream along the gas flow.

2. The fuel cell according to claim 1,
wherein the cathode separator has ribs for forming the gas passage, and a rib height of R₁ at an inlet of the gas passage and a rib height of R₂ at an outlet of the same are set to R₁ <R₂.

3. The fuel cell according to claim 2,
wherein the rib heights of R1 and R2 are set to 0.2 mm≦R₁≦0.7 mm and 0.6 mm≦R₂≦2.0 mm.

4. The fuel cell according to claim 1,
wherein the cathode separator has ribs for forming the gas passage, and a rib pitch of L₁ at an inlet of the gas passage and a rib pitch of L₂ at an outlet of the same are set to L₁<L₂.

5. The fuel cell according to claim 4,
wherein the rib pitches are set to 1.0 mm≦L₁≦3.0 mm and 3.0 mm≦L₂≦9.0 mm.

6. The fuel cell according to claim 1,
wherein the fuel is hydrogen, and the hydrogen is fed to the anode catalyst layer through the gas passage of the anode separator from a hydrogen storage-feed system, and
wherein the hydrogen storage-feed system implements the hydrogen storage-feed by using a hydrogenation reaction of a hydrogen storage comprising aromatic compound and a dehydrogenation reaction of hydrogen supply comprising hydrogenation derivative of the aromatic compound.

7. A polymer electrolyte fuel cell for working at 100° C. or higher, comprising an anode catalyst layer to oxidize fuel, a cathode catalyst layer to reduce oxidant gas, an ionic conductor interposed between both catalyst layers, diffusion layers placed outside the anode and cathode catalyst layers, and an anode separator and a cathode separator placed outside the diffusion layers,
wherein a contact area between the anode separator and the anode diffusion layer is larger than that between the cathode separator and the cathode diffusion layer.

8. The fuel cell according to claim 7,
wherein the cathode and anode separators have ribs for forming the respective gas passages, and a rib pitch of Lc of the cathode separator and a rib pitch of La the anode separator are set to Lc>La.

9. The fuel cell according to claim 7,
wherein the rib pitches of Lc and La are set to 1.5 mm≦Lc≦9.0 mm and 1.0 mm≦La≦2.0 mm.

10. The fuel cell according to claim 7,
wherein the cathode and anode separators have ribs for forming the respective gas passages, and a rib width of Wc of the cathode separator and a rib width of Wa of the anode separator are set to Wc<Wa.

11. The fuel cell according to claim 9,
wherein the rib widths of Wc and Wa are set to 0.5 mm≦Wc≦1.0 mm and 1.0 mm≦Wa≦2.0 mm.

12. The fuel cell according to claim 7,
wherein the fuel is hydrogen, and the hydrogen is fed to the anode catalyst layer through the gas passage of the anode separator from a hydrogen storage-feed system, and
wherein the hydrogen storage-feed system implements the hydrogen storage-feed by using a hydrogenation reaction of a hydrogen storage comprising aromatic compound and a dehydrogenation reaction of hydrogen supply comprising hydrogenation derivative of the aromatic compound.
